(19) United States
(12) Patent Application Publication
(10) Pub. No.: US 2011/0102424 A1
(43) Pub. Date: May 5, 2011

(54) STORYBOARD GENERATION METHOD AND SYSTEM

(75) Inventors: Jerry Hibbert, London (GB); Danny Van Der Ark, The Hague (NL)

(73) Assignee: HIBBERT RALPH ANIMATION LIMITED, London (GB)

(21) Appl. No.: 12/936,139

(22) PCT Filed: Apr. 2, 2009
(86) PCT No.: PCT/GB09/50323

§ 371 Date: Dec. 23, 2010

(30) Foreign Application Priority Data
Apr. 2, 2008 (GB) 0805924.8

(51) Int. Cl. G06T 15/00

(52) U.S. Cl. 345/419

(57) ABSTRACT

A computer-implemented method for generating a storyboard image is disclosed. The method comprises retrieving three-dimensional image data defining at least one three-dimensional object; rendering the three-dimensional image data from a predefined viewpoint to generate two-dimensional background image data including a two-dimensional representation of the or each three-dimensional object visible from the predefined viewpoint; and superimposing two-dimensional foreground image data over the two-dimensional background image data to generate a composite two-dimensional image representing the storyboard image.

This invention relates to a computer-implemented method for generating a storyboard image or a sequence of such images. It also relates to a system for generating storyboard images and a computer program for implementing the method.

A storyboard is a sequence of images displayed for the purpose of giving a simple impression of a finished motion picture product before the expense of producing the motion picture is incurred. The images are typically created by skilled illustrators and are quite labour intensive to produce, albeit less so than the production of the finished motion picture to which they relate.

Storyboards provide a quick and effective means for communicating the shots, scenes and action that will be required in order to complete all the shots and scenes used in a television series or film. Traditionally, storyboards have been drawn using paper and pencil. More recently, storyboards have been created on computers as digital drawings or rough three-dimensional layouts. Both of these methods have associated disadvantages.

Traditional hand-drawn storyboards require the frame and background to be redrawn for each shot. Furthermore, in order to present these drawn storyboards using a computer they have to be scanned or digitised, which is a time-consuming process.

Whilst storyboards drawn on a computer do not require scanning, the artist is still required to draw foreground and background detail.

Three-dimensional storyboards are convenient, especially where the motion picture is animated film. They may be drawn on a computer, but it is difficult for the artist to add detail to the elements of the storyboard, for example character details such as facial expressions. These details are important for the storyboard to successfully convey the intended impression of the finished motion picture.

Prior three-dimensional storyboards either provide no direct relationship between the three-dimensional storyboard and any final three-dimensional production models or they lack the speed, subtlety and finesse of drawn boards. All these problems can result in artists creating shots that cannot be accurately reproduced in the final production and/or lack enough detail to accurately communicate the story.

In accordance with one aspect of the present invention, there is provided a computer-implemented method for generating a storyboard image, the method comprising:
i) retrieving three-dimensional image data defining at least one three-dimensional object;
ii) rendering the three-dimensional image data from a predefined viewpoint to generate two-dimensional background image data including a two-dimensional representation of the or each three-dimensional object visible from the predefined viewpoint; and
iii) superimposing two-dimensional foreground image data over the two-dimensional background image data to generate a composite two-dimensional image representing the storyboard image.

This method allows three-dimensional objects to be manipulated and rendered to generate a desired scene with most of the detail of the scene already present. The three-dimensional objects would typically already have been created, and if not only need to created one. They may also be low-polygon objects which can be immediately rendered. The two-dimensional foreground image can be drawn by an illustrator over the desired ones of the three-dimensional objects to provide subtle details such as facial expressions and the like. The foreground and background images can then be easily composited together. The invention therefore overcomes the problems stated above.

The three-dimensional image data typically defines one or more three-dimensional objects as a collection of points in three-dimensional space connected by various geometric entities such as triangles, lines and curved surfaces.

The three-dimensional image data typically also includes a definition of each object's location and orientation relative to an origin.

Often, the three-dimensional image data is manipulated prior to the step of rendering the three-dimensional image data. For example, the location and/or orientation of the at least one three-dimensional object can be adjusted as required to set out the at least one three-dimensional object for use in a predefined scene or shot.

In a preferred embodiment, the two-dimensional foreground image data comprises an alpha channel and the superimposing step comprises alpha compositing of the two-dimensional foreground image data over the two-dimensional background image data.

As will be appreciated by those skilled in the art, an alpha channel is additional information provided alongside the standard RGB colour value for a pixel in an image. The value of the alpha channel can be anything from 0 to 1 inclusive and indicates the transparency of the pixel, 0 being transparent and 1 being opaque.

The alpha channel can be used in a compositing process known as alpha compositing in which the value of the alpha channel in a foreground image is used to superimpose that pixel over a background image. Thus, if the alpha channel value for a pixel is 0 (i.e. transparent) then it will not have any effect when superimposed over the corresponding pixel in the background image. However, if the alpha channel value for a pixel is 1 (i.e. opaque) then the corresponding pixel in the background image will be entirely obscured. If the alpha channel value lies between 0 and 1 then the pixel resulting from superimposition will have a colour depending on both the colour and alpha channel values of the corresponding pixels from both the foreground and background images. The formula for calculating the resultant colour is:

Cₒ=Cₐαₐ+C_{b}α_{b}(1−αₐ)

where:
Cₒ is the colour of the resultant pixel
Cₐ is the colour of the foreground pixel
C_{b} is the colour of the background pixel
αₐ is the alpha channel value of the foreground pixel
α_{b} is the alpha channel value of the background pixel

Rather than using an alpha key for compositing, a colour key can be used. In this technique, the two-dimensional background image data will replace the corresponding pixels in the two-dimensional foreground if those pixels have a certain, predefined colour. For example, the features of the foreground image may be drawn in black whilst the remainder of the image is white. The white pixels in the foreground image are simply replaced with the corresponding pixels from the two-dimensional background image. One advantage of this technique is that the processing involved in the compositing step is relatively quick to perform.

Thus, the superimposing step may comprise a colour key process in which each pixel of a first colour in the two-dimensional foreground image data is replaced by a corresponding pixel in the two-dimensional background image data. The pixels in the two-dimensional background image data which correspond to the pixels in the two-dimensional foreground image data are those having the same co-ordinates. The first colour may be a single absolute value or it may be a range of values.

Preferably, the two-dimensional background image data is modified prior to carrying out step (iii) by superimposing a partially-transparent layer over the two-dimensional background image data.

This layer is usually white in colour. The superimposition is typically performed using the alpha compositing process described above, each pixel of the partially-transparent layer having a fractional alpha channel value. The purpose of superimposing this layer is to reduce the contrast of the background image so that the foreground image is more visually prominent.

One or more elements of the two-dimensional foreground image data may be at least partially generated by auto-tracing respective three-dimensional objects.

One possible way of auto-tracing each of the respective three-dimensional objects comprises creating first and second duplicates of the respective three-dimensional object; identifying each polygon within the second duplicate; calculating a normal for each identified polygon; moving the polygon along the normal and away from the centre of the object by a predefined distance; inverting the normal for each polygon; and rendering the first and second duplicates without any shading or lighting, thereby generating a two-dimensional outline of the respective three-dimensional object.

The term “rendering” is used in the sense that it is typically used in 3D computer graphics, i.e. the generation of an image (in this case a 2D image) from a model (in this case a 3D model).

The term “inverting” in respect of the surface normals means that the direction that the normal points in is reversed by 180 degrees. Thus, whilst the normals originally pointed outwardly away from the centre of the model, once inverted they point inwardly.

Typically, the method further comprises storing two associated files, one containing the three-dimensional image data defining the or each three-dimensional object and the other containing the two-dimensional foreground image data.

Thus, any manipulation of the at least one three-dimensional object that has been made may also be stored so that it does not need to be manipulated again. Also, data defining the predefined viewpoint may be stored along with the three-dimensional image data.

Preferably, the method further comprises periodically comparing a timestamp associated with each of the two files, the timestamp indicating the time of the last modification of the two files, with a pre-recorded timestamp, the pre-recorded timestamp being updated after the comparison.

By comparing the timestamp associated with the two files with the pre-recorded timestamp in this way, it is possible to detect whether the files have been updated since the pre-recorded timestamp was last updated, which is coincident with the previous comparison. Thus, it is possible to determine if another user has modified the files, and to load these modified files in preference if desired.

The method may further comprise storing one or more text annotations.

In some instances it may be desirable to superimpose the or each text annotation over the composite two-dimensional image representing the storyboard image.

In the same or other instances it may be desirable to superimpose a name, such as a filename, associated with one of the two associated files over the composite two-dimensional image representing the storyboard image.

Typically, the method further comprises defining one or more characteristics of a virtual camera located at the predefined viewpoint, the rendering of the three-dimensional image data being done in accordance with the or each characteristic of the virtual camera.

The characteristics of the virtual camera may include details of its orientation and also optical details such as characteristics of a lens (e.g. the focal length, aperture, shutter speed etc.).

The method may further comprise responding to user input requesting movement of the predefined viewpoint by determining the current location of the predefined viewpoint; calculating a new position for the location of the predefined viewpoint dependent on the user input; and changing the location of the predefined viewpoint to the new position unless the path between the current and new locations of the predefined viewpoint passes through a surface of one of the or each three-dimensional objects. Clearly, steps (ii) and (iii) (i.e. rendering and superimposing the two-dimensional image data) will normally be repeated after moving the predefined viewpoint.

The method may further comprise responding to user input requesting movement of one of the or each three-dimensional objects by adjusting the location of the three-dimensional object in accordance with the user input and snapping the three-dimensional object such that a predetermined surface of the three-dimensional object is positioned in alignment with a predetermined surface of another object if the three-dimensional object is moved within a predefined range of the predetermined surface of the other object.

In the context of this invention and specification, the term “snapping” is used in the same sense that it is conventionally used in computer graphics. That is snapping allows an object to be easily positioned in alignment with grid lines, guide lines or another object, by causing it to automatically jump to an exact position when the user drags it to the proximity of the desired location.

In accordance with a second aspect of the invention, there is provided a method for generating a sequence of storyboard images, the method comprising performing the method of the first aspect successively to generate each of the storyboard images in the sequence.

Each of the storyboard images in the sequence is typically associated with a respective duration, the respective durations defining the duration for which each of the storyboard images in the sequence is displayed for when the sequence is played. A default duration can be assigned to each panel by the system.

In a preferred embodiment, the respective durations associated with each of the storyboard images is retrieved from an edit decision list.

The method may further comprise selecting first and second storyboard images in the sequence as first and second keyframes respectively, the first and second keyframes defining start and finish locations for the at least one three-dimensional object and/or the predefined viewpoint; and calculating appropriate locations for the at least one three-dimensional object on each of the storyboard images in the sequence between the first and second keyframes by interpolation between the start and finish locations. The calculated locations are used to position the at least one three-dimensional object in each image in the sequence before it is rendered in step (ii).

The method may further comprise generating a route sheet comprising data related to each of the storyboard images in the sequence. The type of data that may be comprised in the route sheet are specified below.

In accordance with a third aspect of the invention, there is provided a system for generating a storyboard image or a sequence of storyboard images comprising a processor adapted to perform the method of the first aspect.

In accordance with a fourth aspect of the invention, there is provided a computer program comprising computer-implementable instructions, which when executed by a programmable computer causes the programmable computer to perform a method of the first aspect.

In accordance with a fifth aspect of the invention, there is provided a computer program product comprising a computer program, which when executed by a programmable computer causes the programmable computer to perform a method in accordance with the first aspect.

An embodiment of the invention will now be described with reference to the accompanying drawings, in which:

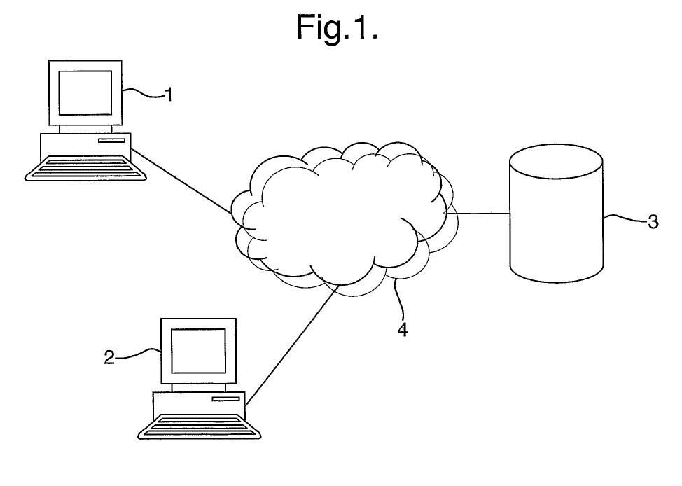

FIG. 1 shows a computer system on which the invention may be implemented.

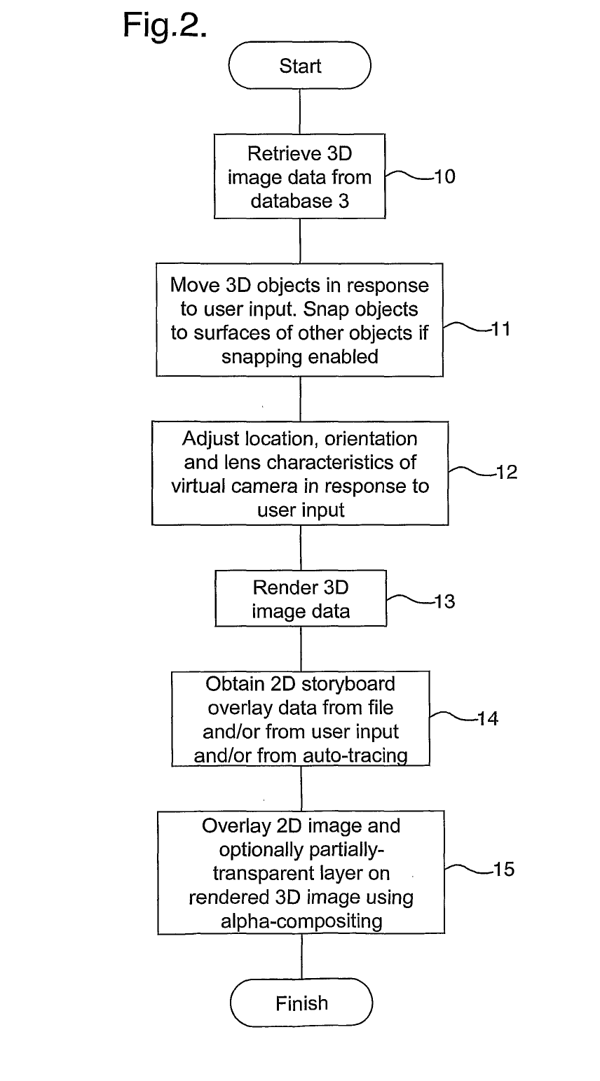

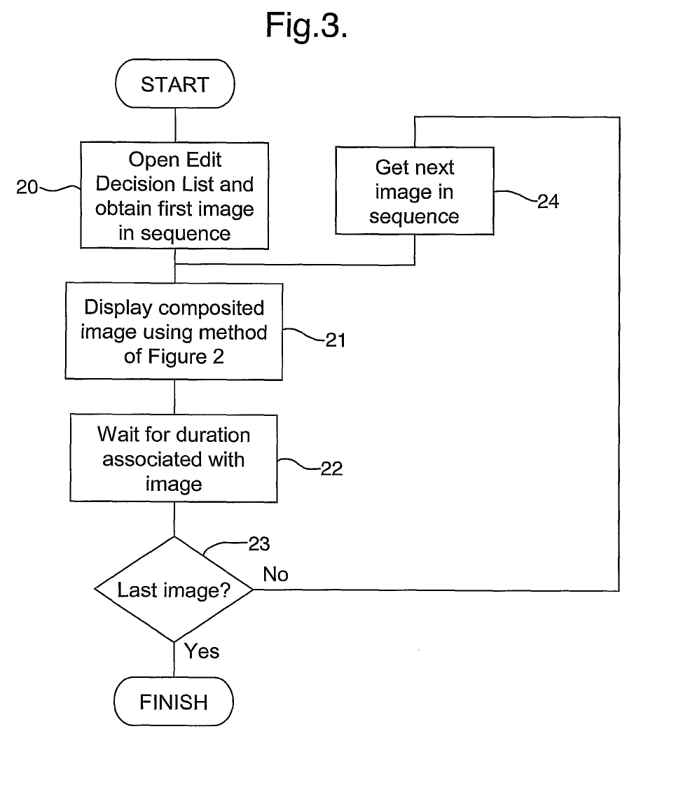

FIG. 2 shows a flowchart of a method for generating a storyboard image.

FIG. 3 shows a flowchart of a method for playing a sequence of such storyboard images generated using the method of FIG. 2.

In the system shown in FIG. 1, two workstations 1 and 2 are able to access a database 3 via a network 4. The database 3 acts as a repository for a library of 3D objects for use by storyboard creation software, which also stores its own data files on the database 3. The data files, as explained below, are stored in pairs, one containing 3D image data including details of 3D objects used in a particular image or panel and the other containing a 2D image for superimposition over an image rendered from the 3D image data. The composite image forms the storyboard panel.

Thus, the system does not make use of a conventional relational database such as Oracle or MySQL (although it could) for storage of system data. Instead, it makes use of the file system which is provided by the operating system. There are a number of advantages to this. First, the database 3 is less prone to catastrophic failure because the failure of any single file does not result in the corruption of the whole database.

It also allows for elements of the database 3 to be copied easily and/or moved to a totally separate machine. This is very important for storyboard artists who often work remotely, sometimes without any network or Internet connectivity.

The use of two (or more) networked workstations 1 and 2 allows two (or more) artists to collaborate on the same storyboard. As explained below, a mechanism exists, whereby the system can detect when another artist has made changes to a file on which he or she is working and update the presentation of the 2D and 3D data as required.

The structure of the database 3 allows for individual storyboards, with their associated 3D libraries, to be relatively easily copied and/or moved to a remote or isolated computer.

Of course, the system can operate on a single workstation which runs the storyboard creation software and hosts the repository of data.

FIG. 2 shows a flowchart for creating storyboard images or panels using the workstations 1 and/or 2. The method starts in step 10 by retrieving 3D image data from the database 3. The 3D image data comprises a set of 3D objects, for example characters and vehicles and landscape features. These objects may be moved around in step 11 if desired to position them appropriately for the storyline being conveyed. If the snapping feature is enabled (explained in more detail below) then one or more of the objects may snap to align with another object as it is moved. For example, a character's feet may snap to align with a surface defining the ground as it is moved in close enough proximity to the surface.

The characteristics of a virtual camera from which the scene is to be rendered may then be adjusted in step 12. The location and orientation of the virtual camera may be adjusted along with characteristics of the lens. Movement of the virtual camera varies the predefined viewpoint from which rendering takes place.

Next, in step 13 the 3D image data is rendered from the viewpoint of the virtual camera to form a 2D background image.

In step 14, the 2D foreground overlay image is obtained. This may be by simply opening a file containing the overlay image or the image may be drawn by an artist at workstation 1 or 2 or use may be made of the auto-tracing feature which allows the outline of 3D objects to be automatically traced in the 2D foreground image. A combination of these may be used in step 14.

Finally, in step 15 the 2D foreground overlay image is composited with the background image. It is preferred if the background image is firstly composited with a partially-transparent white layer, which reduces the contrast of the background layer so that the foreground layer appears more visually prominent after compositing.

A sequence of images may be created using this method to form a complete storyboard for a motion picture. FIG. 3 shows a flowchart for a method of playing back such a sequence after creation. Before this method is invoked the sequence of images is exported from the software into editing software (as explained in detail below) and this editing software is used to generate an edit decision list, which associates each image in the sequence with a duration for playback.

In step 20, the edit decision list is opened and the first image in the sequence is read from the list. This image is opened and displayed by rendering the 3D background image data and compositing with the foreground 2D image data already generated in step 21. Step 22 causes the display to remain for the duration associated with the image.

In step 23, processing transfers to step 24 if the last image in the sequence has not yet been reached. Otherwise, processing ends. In step 24, the next image in the sequence is determined from the edit decision list, loaded in and then steps 21 and 22 are repeated on that image.

This sequence of events (i.e. loading the next image as determined from the edit decision list and then rendering the 3D image data and compositing with the foreground image data) is repeated until all of the images have been displayed for their associated durations as defined by the edit decision list.

The partially-transparent white layer may or may not be displayed as in the method defined by the flowchart of FIG. 2.

A more detailed description of the operations performed by the storyboard generation method used to implement this invention is set out below in the form of a description of the workflow used to generate a storyboard. It will be clear from this description of the workflow how the flowcharts set out in FIGS. 2 and 3 relate to the features discussed below. The description of the workflow also discusses various other aspects of the methods that are not set out in FIGS. 2 and 3.

In the following description, it should be assumed that all storage of data is carried out by database 3 and all data and image processing steps are carried out on either workstation 1 or 2.

In order to initiate the operation of the system the storyboard artist is required to define a “storyboard project”, which usually represents the title of the particular television series or film production in question. The system can contain any number of storyboard projects and each project can contain multiple storyboards. In order to enable the unique identification of individual storyboard panels, when the storyboard artist creates a new storyboard project they are required to define a “panel name convention” for that individual project. This panel name convention consists of a user understandable caption and prefix and a numbering system used by the system's internal database.

The numbering system used by the internal database assigns a unique number sequence to any individual storyboard panel and consists of a series of numbers, where any number in the sequence, provides a container for the following number or set of numbers. These panel numbers then hold sequential indices that are automatically sorted numerically in ascending order and provide each panel's order of appearance within a given storyboard ‘timeline’.

Whilst internally the system uses the unique number sequences and indices to reference individual panels, when defining a project's panel naming configuration, the storyboard artist additionally specifies a ‘caption’ and ‘prefix’ which is used in the system's interface, to more quickly enable access to individual storyboard panels and provide the storyboard artist with a user-understandable panel navigation structure.

For each panel, the storyboard artist can set the number of digits used to build the index number as well as a caption and prefix. The prefix acts as a separator to the previous panel series index number and aids readability for the storyboard artist. Additionally the storyboard artist can specify a default index number to use when creating a new storyboard or storyboard panel. Typically, this is set to a value of 1

For example in the context of a television series the following set of two panel indices would suffice: episode number, panel number.

Index 1 (Episode Number): caption=“Episode”, number of digits used=2, prefix=“Ep”, default=1

Index 2 (Panel Number): caption=“Panel Number”, number of digits used=3, prefix=“_panel”, default=1

At the outset of the production this would produce a naming convention where the first panel in the first episode will be referred to as “Ep01_panel001”

To be able to store, address and load a panel, the system requires a project to be configured to use at least two different types of panel name. The first panel name (Ep01 in the above example) is always considered to contain the ‘storyboard number’ (or ‘timeline number’) and the last panel name always contains the ‘storyboard panel number’ (panel001 in the above example).

However, for production and resource management reasons in a television series context, a project could be configured to contain a series of panel captions (and prefixes) such as Episode (Ep), Scene Number (Sc), Shot Number (Sh), Panel Number (Pn) etc.

This would equate to:

Panel number index 1: caption=“Episode”, number of digits used=2, prefix=“ep”, default=1
Panel number index 2: caption=“Scene Number”, number of digits used=3, prefix=“_sc”, default=1
Panel number index 3: caption=“Shot Number”, number of digits used=3, prefix=“_sh”, default=1
Panel number index 4: caption=“Panel Number”, number of digits used=3, prefix=“_pn”, default=1

At the outset of the production this would produce a naming convention where the first panel in the first episode will be referred to as “ep01_sc001_sh001_pn001”

To further aid the initial configuration of a storyboard project, this “panel name configuration” can be selected by the storyboard artist, from a library of “standard” panel name configuration presets as well as being tailored for a particular production environment if required.

Additionally, the system allows the user to enter non-integer decimal numbers (as opposed to integers which the system will use by default) to enable the storyboard artist to insert a new panel between two existing sequential (integer) panel number indices. So in order to insert a panel between ‘panel 1’ and ‘panel 2’ a ‘panel 1.5’ can be created. Since panels are sorted by index, this results in the sequence: “panel001”, “panel001.5” and “panel002”. Should it then be necessary to insert a panel between 1 and 1.5 a panel with index 1.25 can be created. By utilising this methodology the system allows any amount of additional panels to be inserted between two other panels.

Version control is also supported and achieved by inserting a “version controller” panel index between two existing panel indices and flagging it specifically as a “version controller”. This will result in the user being able to create alternate versions of storyboard panels for a given group as defined by the panel name flagged as being the version controller.

For example, an initial panel name configuration may specify the following panel captions: “Episode, Scene, Shot, Panel”. Alternatively a “version controller” may be inserted between “Shot” and “Panel” resulting in: “Episode, Scene, Shot, Version, Panel”. Now the storyboard artist could create multiple versions of a “shot” by creating a new set of alternative “Panels”. Similarly if one were to insert a version controller between “Scene” and “Shot” to get: “Episode, Scene, Version, Shot, Panel” the user can create multiple versions of a scene by creating alternative shots and panels.

By offering filtering options, version control enables the user to “play” only the last versions of a storyboard timeline sequence or to export only the last versions of storyboard timeline sequence. When a storyboard project's panel naming convention contains a version controller, the storyboard artist can at any time choose to enable or disable this feature, thereby re-enabling “play all versions” or “export all versions” as required.

The system also supports the inclusion of “production related” text annotations, by allowing each panel to contain any number “production related” data fields. The storyboard artist will typically define these production data fields once the panel name configuration has been determined. These data fields enable a storyboard artist to include additional “production” related text annotations for specific production data, such as Camera Motion, Action, Special Effects, Lighting etc. These notes are then stored with the corresponding panel.

Each individual storyboard panel is stored as a pair of files. The first file is a data file containing a unique panel number (ID number), the panel name in text format (according to the panel naming convention), the creation username (i.e. the name of the user who created the panel), creation timestamp (i.e. the time and date that the panel was created), “last modified by” username (i.e. the username of the user who last modified the panel), “last modified timestamp” (i.e. the time and date when the last modification was made to the panel), the camera position (including its height from the floor/surface underneath), the camera orientation, details of the camera lens (e.g. focal length), the set model (a unique model ID defining the model used as the background set), the set position, the set orientation, panel name values per index (in database/numerical format as defined in panel naming convention), production fields, and a unique ID and position and orientation of each model populating the panel. The second file is a bitmap image that stores the associated freehand drawing along with the alpha channel information.

For reasons of speed and efficiency, the system creates a separate folder for each storyboard, into which the pairs of files corresponding to the panels for that individual storyboard are saved. In order to present a specific storyboard to the storyboard artist, the system scans the storyboard folder and parses the filenames of each individual file in order to rebuild a storyboard in memory. By storing each individual storyboard in a separate folder the system can quickly find and address a specific storyboard timeline. This storyboard timeline can then be played or presented in a sequential order, respecting the underlying hierarchical structure of the panels, as defined by the naming convention specified for that particular project.

The system's file-based storage solution enables a number of storyboard artists to collaborate on multiple projects or on a single storyboard timeline. On a local area network this is achieved simply by granting users across the network access to a shared location where the system stores its data, such as database 3. On a wide area network the same result can be achieved by setting up a Virtual Private Network or similar solution. A combination of the two allows people within the same building as well as remote workers (via the internet) to collaborate on multiple storyboard projects and the corresponding individual storyboard timelines.

To further assist a multi-user situation, the system creates a timestamp for each panel as mentioned above. Each time a panel is created or a change to a panel is saved to disc the timestamp will be updated. This also causes the timestamp for the folder containing the panel data files to be updated. When any user is working on a specific project and specific storyboard timeline or panel, the software will periodically check the timestamp of the corresponding folder to see if any updates have been made to the content of the data folders since the timestamp was last checked. If an update has been made then the timestamps in the files for each panel within that folder are checked and compared with a database in the system memory to find out which panel(s) is(are) affected. The updated data can then be retrieved from the affected panels. Optionally, the system can update the given user's information accordingly. Alternatively, the automatic update mechanism can be disabled and updates will then only be carried out in response to a manual command.

Ideally, a number of pre-existing 3D digital sets (or “virtual stages”) are constructed prior to storyboarding. These digital 3D sets provide the individual storyboard panels with a “virtual stage” or “background” and the system allows multiple 3D sets to be saved in a library corresponding to each storyboard project and accessible by the storyboard artist. The library provides a real-time visual preview of the set in question (utilising a default camera position) so the correct set can be easily chosen. These 3D sets may also have associated textures and/or images, which provide an additional level of detail when the sets are presented to the storyboard artist.

The system also supports the use of textured 2D “flat planes”. By utilising a transparency (or alpha) channel within the associated texture, the 2D plane can be placed within the 3D sets and used to quickly fill in large areas of background panorama without requiring the complete construction of 3D sets and objects. For example, these 2D planes can be used to add hills or buildings in the far distance of a 3D set without requiring the construction of all the corresponding 3D objects needed for the distant panorama. Finally, the use of a “sky-dome” (a hemi-spherical 3D object, with an associated “sky” texture) can be used to encapsulate the whole 3D set (plus any associated textured 2D planes) in a complete 3D environment.

Additionally, 3D digital objects (such as characters, props, vehicles etc.) can also be constructed prior to storyboarding for use in the system. These 3D objects can be used to populate the 3D sets if so desired. Again the system allows multiple 3D objects to be saved in a library corresponding to each storyboard project and accessible by the storyboard artist. Again the 3D object library provides a real-time visual preview of the model or prop in question (utilising a default camera position) so the storyboard artist can easily choose the correct model or prop for any particular panel. Depending on the nature of the storyboard the system allows for these models to be loaded into memory as required or loaded as a set when the application starts.

Once all the 3D sets and 3D objects have been imported into the system libraries they can be assigned to “model groups” which enables collections of similar models (e.g. all characters, all vehicles, all sets) to be grouped together for easier management by the storyboard artist. These model groups allow models to exhibit similar characteristics within the system as explained below.

In order to optimise the performance of the system, both the 3D digital sets and 3D digital objects (such as character and prop models) are low polygon proxies (or maquettes) of the final models that will ultimately be used in the finished production. In order to ensure the efficient transfer of data from the system to other 3D applications it is essential that these 3D sets and the corresponding 3D objects must be correctly scaled and proportioned relative to each other at the outset of the production. To optimise storyboarding the proxies should provide an accurate representation of the major features that will be included in the final model (such as windows and doors in a building or vehicle). However, the proxies do not necessarily need to include say all the slates on a roof or the spokes on a car wheel. The proxies may also include any features that the storyboard artist might feel would be beneficial such as door handles and other features a character may directly interact with.

If none of the digital 3D sets, 3D object models (such as characters and props), textured 2D planes or skydomes are available at the outset of storyboarding, using a single 3D representation of a white 2D plane the system enables simple “free hand” drawings to be saved utilising the underlying data management structures that have been optimised for TV series/film production. So the storyboard artist could choose to draw the complete panel “by hand” if they so choose, but the individual panel can still be saved using the underlying data management structure discussed above.

The system uses an existing commercial 3D Engine known as Blitz3D, which in turn utilises Microsoft's DirectX programming interface, to enable a real-time 3D graphics display. By combining the use of 3D sets, 3D objects (such as characters, props, vehicles, etc.), 2D planes and skydomes with the 3D engine, the system enables the storyboard artist to quickly visualise the complete working environment in which they plan to create the storyboard.

By utilising the 3D engine, this mathematically-accurate representation of the 3D environment (including any associated images and textures) can be visualized or “rendered” to the screen in real-time as a two-dimensional projection and be presented to the storyboard artist via a special viewport window embedded within the system's graphical user interface. This viewport window can be considered as a “virtual camera” with which the storyboard artist can “frame” a particular shot or panel.

Working with a pre-existing written script for a particular episode or sequence enables the storyboard artist to select a 3D set from the 3D set library (as detailed previously above), to provide the setting (or “backdrop”) in which the story is to take place for that particular storyboard panel. The virtual camera can be manipulated by using a mouse (or digital tablet) and keyboard shortcuts, so as to move around the rendered 3D set in real-time. In order to facilitate the movement of the virtual camera, the 3D sets can be defined as “locked” to make sure that they do not move if a storyboard artist selects them (see below for more details on object placement).

By enabling free movement of this virtual camera in three dimensions the storyboard artist can appear to fly or walk around the digital 3D set in real-time.

By further enabling pitch and roll options for the camera plus the option to adjust the focal length of the camera lens, the virtual camera allows for any number of shots to be considered for a particular storyboard panel. Once the storyboard artist is satisfied with the particular framing of the digital 3D set, as viewed through the virtual camera, and thereby creating the required shot for that particular storyboard panel, the camera's location and orientation within that 3D set can be saved as a storyboard panel and stored within the underlying data storage structure discussed above.

By using an optional collision-detection system the virtual camera is prevented from penetrating and entering surfaces of the 3D sets and other 3D objects. For example, this prevents the camera appearing to be placed under the ground or inside a wall, which typically is considered undesirable. As a result the system ensures that, in the vast majority of cases, the storyboard panels can be easily transferred to alternative 3D systems, without the need to check that the storyboard artist has not placed cameras in or behind walls or in the ground. However, the storyboard artist can enable and disable this collision-detection system at will should this be required for the creation of a particular shot.

The collision system works as follows. The virtual camera is defined as a point in space at a given position and rotation (the size of the camera lens can be ignored in this context). A collision radius and collision behaviour are defined for the virtual camera. A possible collision behavior could be for the virtual camera could be to stop moving at the collision site or to slide along the surface it has collided with, for example. Then all the 3D models in the current environment (set+models) are flagged to be ‘collision objects’ as well, i.e. they are capable of colliding with the virtual camera.

The camera collision radius can be considered as an invisible sphere around the camera that can be used to detect it's proximity towards any other object's surface (polygons) in the current environment. When the camera is instructed to move a given distance in a given direction, the system first checks to make sure that the virtual camera's collision sphere doesn't intersect with any of the objects in the current environment that are currently flagged as collision objects and lie directly in the camera's path. It does this check before moving the camera and does so by checking every nearby object's polygon. If no collision is detected, the camera will be moved as previously instructed. If a collision is detected however, the camera will automatically be placed along the request path but at a distance equal to that of the camera's collision radius from the surface(s) it collided with. The collision system then prevent the camera from penetrating that surface, and instead it may stop or slide along the surface closest to the direction initially requested (but thus at an angle to the intended path of motion), depending on the collision behaviour.

This collision-detection system can also enable storyboard artists to create storyboards for a “real world” modelled environment that physically exists. In some television series and film productions full-size accurate models are constructed for some or all of the production. As the collision detection within the system effectively limits the position of the virtual camera in the 3D environment, this virtual camera data can be translated for use on a real camera situated on a motion control rig which is also limited to a physical space, by the rig and the models around it in the “real world”. This again ensures that the storyboard artist does not create shots that the real camera on the motion control rig is not able to recreate, as it physically cannot pass through the walls (of models) or the floor (the physical set).

Once the correct 3D set has been framed by the virtual camera to the satisfaction of the storyboard artist, additional 3D objects (e.g. characters, props and vehicles) can be added to the set and stage the action to take place. Like the 3D sets the 3D objects can contain associated textures (and 2D image planes if required).

By selecting a 3D object from the 3D object library, the system allows the storyboard artist to place a 3D object within the virtual set. When the 3D objects are initially constructed for use within the system, by placing the pivot point of the 3D objects in line with the base of the 3D object (e.g. the soles of a character's feet, or the base of a vehicle's wheels) the system can support a number of alternative placement settings. By utilising the model groups discussed above these placement settings can be applied to groups of 3D objects and sets. The placement settings include:
No movement (e.g. often applied to 3D sets)
Stick to surface but remain upright (e.g. often applied to characters)
Stick to surface (e.g. often applied to props)
Free movement (e.g. often applied to flying objects)

The storyboard artist places the 3D objects using a mouse or a digital tablet and by interpreting the surface normals of the 3D sets and other 3D objects, the system allows 3D objects to snap to the surfaces in a 3D set or other 3D objects. By ensuring that 3D objects such as characters and vehicles snap to the surfaces of the set (e.g. pavements and roads) the system ensures that, by default, the storyboard artist places the 3D objects appropriately within the 3D set. This component of the system ensures, for example, that a character's feet are not floating above the ground or a vehicle's wheels are not embedded in the ground. By using a combination of keystrokes the system allows for this snapping behaviour to be overridden, allowing characters to be moved freely in all three dimensions, for example. Like the collision detection part of the system this snapping function limits the number of undesirable shots that can be created by the storyboard artist.

During the snapping process, the mouse pointer is used to pick the exact spot the user wishes the object to be placed. This spot inside the camera viewport will have to contain a surface (on a part of the set or on a character) for the object snap to.

The system performs a ‘camera-pick’ function, which projects a ray forward from the camera (taking the 2D mouse coordinates into account) and returns if any collision surface has been detected. When a surface has been detected (the ray has collided with a surface) the 3D coordinates of that collision are known, as well as the actual surface that provided the collision point.

With this information the system can simply position the object at the exact coordinates the collision took place.

A rotation to the object may then be applied depending on the behavior set by the model-group the given object belongs to, as detailed below:

1) No movement: does not apply (the system doesn't allow snapping objects when the object's group is defined not to move).
2) Stick to surface but remain upright: after having been positioned at the collision point, the object is simply aligned (rotated) to be vertically upright, regardless of the collision surface's angle.
3) Stick to surface: after having been positioned at the collision point, the object's rotation is aligned with the collision surface's normal (which is a directional unit vector perpendicular to the surface) making the model ‘stand’ perpendicular to the collision surface.
4) Free movement: the system applies the “Stick to surface” method.

Once a 3D object has been placed in a 3D set, by utilising a series of key stokes in combination with a mouse (or digital tablet), the system allows for the 3D objects to be rotated in all 3 axes. This allows characters to, for example, lie down or vehicles to tip on to one side.

By allowing the storyboard artist to select a collection of 3D objects, which may be present on any particular panel, either by using a tick list (for selecting multiple 3D objects that may not be simultaneously visible in the virtual camera), or selecting the 3D objects using a digital tablet or mouse whilst depressing the Shift key if they are all visible through the virtual camera, the storyboard artist has the ability to manipulate the collection of 3D objects as a single entity. For example, a storyboard artist may decide to place a 3D object of a bus within a 3D set with a road. The storyboard artist places the bus on the road. The storyboard artist then adds a number of characters on the bus. The storyboard artist then saves this frame as a storyboard panel. For the next panel the storyboard artist wants to move the bus down the road. By selecting the collection of 3D objects required, using the option described above, the bus and all the characters on the bus can all be moved as a single entity, allowing the storyboard artist to create the next storyboard frame much quicker than if they had to move every 3D object individually.

If any required production data fields (such as camera motion, action, special effects, lighting etc.) have been defined, a storyboard artist can then type additional annotation on to any storyboard panel. These annotations can be optionally superimposed over the 2D drawing layer (see below) and/or the background 3D sets and objects. Saving these text annotations with each panel, and optionally displaying this typed information on each panel enables the accurate communication of these text annotations for use in later aspects of the production pipeline (see below).

By allowing the superimposition of a transparent 2D “hand-drawn” or “sketching” layer over the corresponding 3D virtual camera viewport the storyboard artist, using a drawing tablet, can draw or sketch over the top of the framed 3D set and 3D objects. This superimposition of the 2D “hand-drawn” layer is achieved by utilizing a transparency (or alpha) channel in the 2D drawn layer, which allows the storyboard artist to draw on the 2D drawn layer while still being able to view the 3D sets and 3D objects underneath. By displaying the 2D “hand-drawn” layer (utilising its associated transparency channel) directly on top of the 2D projection of the underlying 3D environment, the storyboard artist (or any other viewer) perceives the two distinct projections as a single unified image.

The storyboard artist, by utilising a drawing tablet (or mouse), can appear to apply a digital pen or brush with varying colours, thicknesses and opacities to the 2D drawing layer and, as a result of the simultaneous projection, over the corresponding 3D sets and 3D objects. By utilising this digital brush, the storyboard artist can quickly add additional details to the existing framed shot. Whilst this hand-drawn detail is usually added initially in black, any other colour can also be selected if required. Details such as facial expression, character and the impression of movement can be added to any storyboard panel. A digital “eraser” is also provided by the system and by linking this eraser to a specific button on a digital drawing pen (utilised with the drawing tablet), it is possible to easily switch between drawing and erasing without any additional key presses. The system offers a number of predefined brush and eraser sizes and colours (as well as allowing the storyboard artist to create their own sizes).

When superimposed onto the underlying 3D rendered layer (or background image), the 2D “hand-drawn” layer (or foreground image) could in certain situations be difficult to interpret visually when parts of both layers have similar texturing or colouring. By inserting an additional white semi-transparent layer or “onion skin” in between the 3D background layer and 2D drawn foreground layer, the visual clarity of the 2D drawn foreground layer is enhanced.

The white “onion skin” layer is superimposed onto the 3D background image layer first, causing the 3D background to be displayed with lower contrast (making the 3D background layer appear “whiter”). The 2D “hand-drawn” layer is then superimposed (using the transparency channel associated with the 2D drawn layer) on to the modified 3D background image. The loss of contrast and increased “whiteness” of the 3D background visually separates the background further from the 2D drawn foreground layer, making the 2D drawn foreground image more visually prominent. This is useful for emphasizing the drawn components of a storyboard panel over the background 3D sets and 3D objects and helps to ensure that the drawn character and detail of a particular storyboard panel can be correctly communicated and interpreted at later stages of the production process. The storyboard artist can enable or disable this “onion skin” layer and decide on its exact colouring and transparency (alpha channel) value.

In order to maximize the speed of drawing for storyboarding purposes this superimposed 2D drawing layer is not linked to the underlying 3D sets and objects. It is only linked in the perception of the viewer and by the system's data storage structure. The two layers (the 2D drawing layer and the 3D background layer) are simply perceived as being visually combined by the viewer. If the orientation of the virtual camera is moved, the corresponding 2D drawing on the superimposed 2D drawing layer does not change, and the perceived visual combination of the two images becomes separated at this point.

Although there is no direct relationship between the 2D drawn layer and underlying 3D sets and 3D objects the system does offer the ability to selectively auto-trace 3D objects that have been added to the 3D sets by the storyboard artist. Once a storyboard artist has selected the 3D object in question, the auto-trace function calculates a 2D trace line (often represented as a black line) around the edges and key features of the 3D object in question.

The auto-trace function first creates an internal or ‘private’ viewport, virtual camera and ‘empty virtual space’ which will remain invisible to the user. This viewport, camera and space have the exact same settings, properties and dimensions to the scene from which the user invoked the auto-trace function.

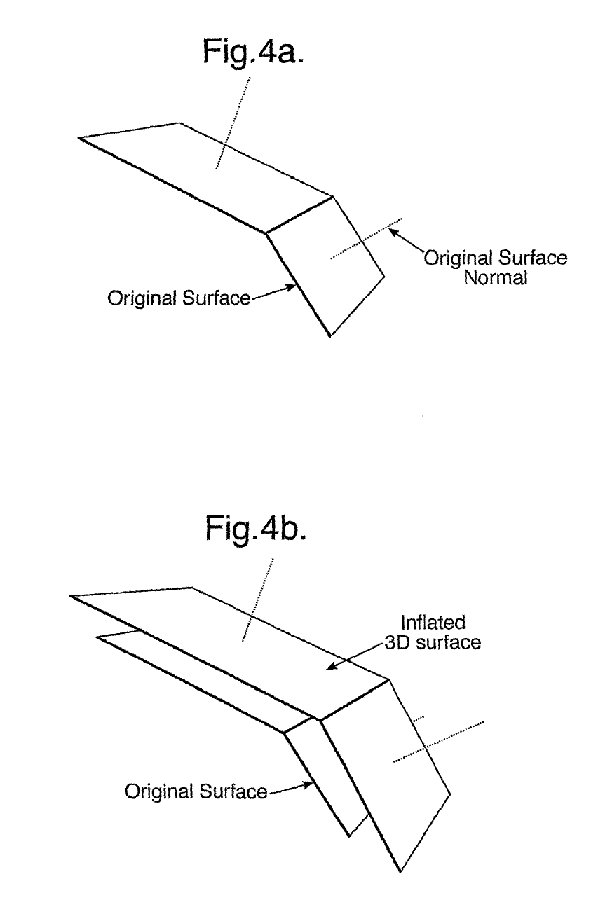

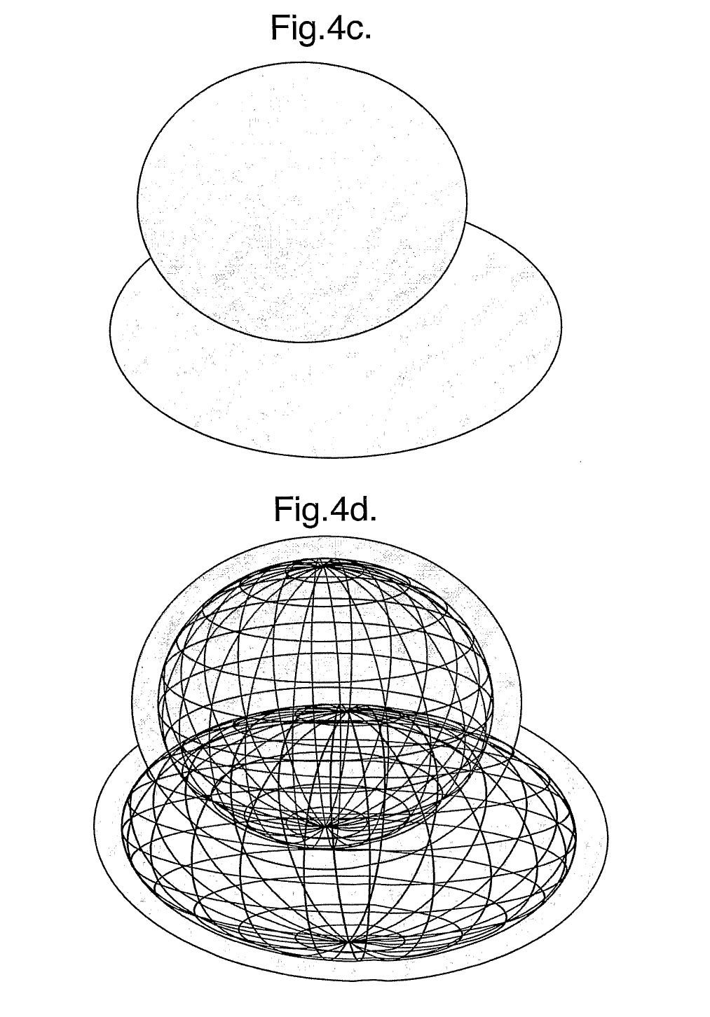

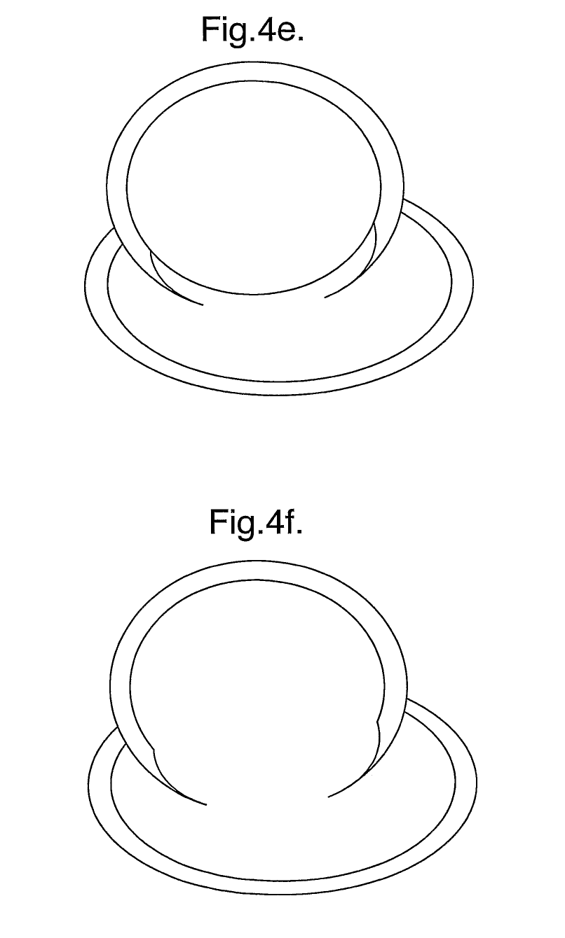

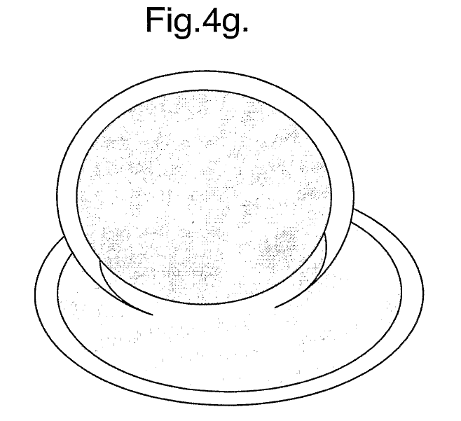

The auto-trace function first creates a copy of the 3D model to be traced (the original') (see FIG. 4c) and then another copy which will become the 3D outline copy of the original model. Note that here ‘a copy’ can indicate one or multiple models (e.g. characters), the same principle applies and merely depends on the user having selected either one or more models to auto-trace.

Then, within the outline copy, the auto-trace function moves each polygon outwardly relative to the centre of the model by a given distance. This distance is based on a given scaling factor (or outline thickness) and the exact direction by which the polygon is moved is based on each individual polygon's surface normal (a vector perpendicular to the given surface). This results in the outline model appearing as an ‘inflated’ copy of the original. FIGS. 4a and 4b illustrate this concept.

In computer graphics a polygon surface is only visible from the direction the normal is pointing. In the above illustration, the polygons are visible because the normal is pointing outward in these examples. If they had pointed inwards, the polygons would not have been visible for rendering.

The auto-trace function then inverts the normals of the outline copy—so that the outline copy is only visible from the inside as opposed to from the outside (see FIG. 4d). If this inversion was not done, then the outline copy (being larger than the original) would simply obscure the original model. Due to this inversion the outline copy is visible behind the original model, and only where it exceeds the size of the original. Thus, it creates an outline around the original.

With both models visible in the private 3D space, the auto-trace function then applies a colour to the original model which is exactly same as the viewport's background colour, and it applies a given color to the outline model. This is illustrated in FIG. 4e. Note that any color combination can be used, provided the colors are different.

Finally, the auto-trace function renders a single frame of the current situation without any shading or lighting to ensure a two-color 2D image containing only the background colour and the outline colour (see FIG. 4f). The background colour is used as a mask and composited with the current panel's freehand 2D drawing or ‘paint layer’. The result is shown in FIG. 4g.

This 2D trace line is then transferred to the corresponding location, directly above the 3D object, on the 2D drawn layer using alpha compositing (or colour-masking). This allows the storyboard artist to quickly auto-trace (or outline) larger objects such as vehicles or other 3D objects that may be in the periphery of the shot without having to draw them completely from scratch. Once the 2D auto-trace is transferred to the 2D drawn layer all the drawing tools that are available to the storyboard artist for the creation and modification of the drawn images, can then also be used on the auto-traced lines.

By offering a number of additional tools, the system aims to minimise the degree by which the drawing layer needs to be redrawn if it later proves necessary to make changes to the orientation of the virtual camera once a panel has been drawn on. By again utilising a digital drawing tablet (or mouse) the storyboard artist can select then scale and/or rotate and/or move and/or delete some or all of the 2D drawing layer to rematch the corresponding 3D scene underneath. If only small changes have to be made to the virtual camera these tools are often enough to allow the repositioning and realignment of the current 2D drawing, overcoming the need for the storyboard artist to completely redraw the panel in question.

Once the storyboard artist has finished adding any drawn elements to the storyboard panels the completed panel can be saved, as a combination of the background 3D set and 3D object data (plus any associated text annotations) in one file, and the corresponding superimposed drawing layer in another file as described above. By utilising the panel numbering and data storage system as detailed above, any individual panel including the virtual camera position framing any 3D sets and 3D objects and the corresponding 2D drawn layer can be retrieved and viewed or modified at a later stage.

The system provides a facility to apply a specific duration (or time) to each storyboard panel by utilising this duration the storyboard artist can then play the panels, which have been created in sequence using a storyboard playback option. The system can set the duration of each panel during the storyboard creation process or the duration can be set via an edit decision list as explained below once the storyboard has been completed. This playback tool allows the storyboard artists to preview the “flow” of the storyboard whilst they are working on it. This playback option also optionally supports the “version controller” discussed above so that only the most recent version of a storyboard sequence or panel will be presented to the storyboard artist. Providing the storyboard artist with a preview function helps to enable them to monitor the continuity within each individual storyboard as a whole.

At any point during the creation of the storyboard, the system allows for the export of the storyboard panels in a variety of computer image formats.

By utilising the underlying panel name convention and hierarchical data storage structure (as detailed above), the storyboard artist can choose which panels are to be exported, ranging from just a single specific panel, or for example, a complete shot or scene, up to the entire sequence of panels. The filenames of the exported panel images can be chosen to conform to the naming convention detailed above so that each individual image file retains a human-readable filename after the images have been exported. These filenames allow the panels to be utilised in other applications but still maintain a reference back to the original storyboard as it exists within the storyboard system.

In an example the file name convention outlined above is used. The file name convention is set out again below for convenience:

Panel number index 1: caption=“Episode”, number of digits used=2, prefix=“ep”, default=1
Panel number index 2: caption=“Scene Number”, number of digits used=3, prefix=“_sc”, default=1
Panel number index 3: caption=“Shot Number”, number of digits used=3, prefix=“_sh”, default=1
Panel number index 4: caption=“Panel Number”, number of digits used=3, prefix=“_pn”, default=1

In this example, the resulting files names would equate to “ep01_sc001_sh001_pn001.bmp” for the corresponding first frame of the sequence, if a Microsoft bitmap image is exported or “ep01_sc001_sh001_pn001.jpg” if a JPEG image is exported.

By selecting one of a number of options when exporting the panel images, the storyboard artist can choose to export just the hand-drawn layer, or the drawn layer superimposed on the corresponding 3D sets and 3D objects. The “onion skin” to highlight the hand-drawn components of the image can be switched on or off. Annotations that may have been added to the panels can be superimposed on the exported images and model labels can be included. Finally, the actual filename of the exported panel can also be superimposed on the exported image. Enabling the filename to be superimposed maintains a visual reference to each individual panel, so each panel can still be identified even when the panels have been converted to an alternative format (such as a DVD or online movie), which otherwise would contain no direct reference to the panels that were used to create the storyboard sequence, as all the individual filenames would be lost when the panels are converted into a single movie file.

Whilst the system can associate a default duration (or time) to each panel, by exporting the individual panels out of the system it is then possible to edit the panels together much more accurately in a video editing system such as Apple's Final Cut Pro or Adobe Premiere. If a guide audio track, which corresponds to the script for a particular episode or sequence is created, prior to editing the individual panels that have been created can be edited to this guide audio track.

This process of editing individual panels to a guide audio track is often referred to as creating an “animatic” of the storyboard sequence. Unlike a traditional storyboard that only shows the sequence of events, an animatic also contains the duration of each panel within the sequence. By creating this “animatic” the editor assigns varying durations to each individual panel that was used to make up the storyboard sequence. At any point in the editing process, an individual panel can be uniquely identified (by using the superimposed file name) and where necessary modified or amended in the storyboarding system and re-exported as required and reinserted into the “animatic” edit.

Once the “animatic” is complete, an Edit Decision List (EDL) can be exported from the editing system being used. The EDL is a simple text file that denotes the files and timings used in any particular edit. The duration (or time) component that now exists for each individual panel used in the “animatic” can be re-imported from the EDL into the storyboard system described here for further processing. By ensuring that all the file names created by the system, when the panels were exported, directly correspond to the underlying naming convention used in any particular storyboard project, any file names referenced in the EDL file created by the edit system can be interpreted by the storyboard system also.

Once this EDL has been imported into the system, the duration of the individual panels (as detailed in the EDL) can be applied to the panels in question (as held in the system's internal database) and a corresponding EDL-based storyboard timeline comprising the duration of individual panels can be created. The storyboard artist, using the system's storyboard playback facility, can now view this EDL-based storyboard timeline with the correct duration applied to each panel.

During the process of editing the “animatic” it is possible that, for creative reasons, some of the panels will become transposed or be placed in a different order, or removed completely, from the original sequence that was originally laid out by the storyboard artist within the system. This may be an individual panel but it may also be complete shots or scenes (containing any number of panels) within the storyboard as a whole. Equally the editor, for reasons of speed and efficiency, may reuse a particular scene (which may be repeated over a number of episodes or sequences) or a scene from a previous episode, in the creation of an “animatic” for a new episode or sequence.

In order to allow for this occurrence, which is quite common in television series and film production, the system presents the storyboard artist with three different options to deal with this scenario.

In the first option, the storyboard artist can manually allocate individual panels to a specific shot and then further allocate multiple shots (each containing any number of panels) to specific scenes. By presenting the panels, as they appear in sequence in the EDL-based storyboard timeline, the storyboard artist can select a series of individual panels and define them as a shot, then group multiple shots into scenes. Once the allocation of panels into shots and scenes is completed the system can then renumber all the scenes and shots starting from 1 and naming each following scene and shot sequentially with no gaps in the number sequences for scenes and shots. By selecting this option the naming convention used in the storyboarding system will be superseded by a new naming convention for the remainder of the production in which all scenes and shots are named sequentially with no gaps based on the order in which they appear in the EDL timeline (rather than the sequence they appeared in the original storyboard timeline). The advantage of this method is that it provides for a sequential number sequence for all scenes and shots for the remainder of the production. The disadvantage is that any link between the individual storyboard panels as created and sequenced in the original storyboard timeline and the panels used in the EDL based timeline is broken.

Alternatively the storyboard artist can allow the system to interpret the EDL and automatically allocate the panels to shots and scenes within the EDL-based storyboard timeline. Using this method the system will present the scenes and shots as they appear with the EDL timeline, but will continue to use the original names applied to the panels as defined in the original naming convention for that particular storyboard project.

For example an original storyboard sequence might consist of three scenes, with each scene containing two shots and each shot containing two panels, this could be represented as follows:

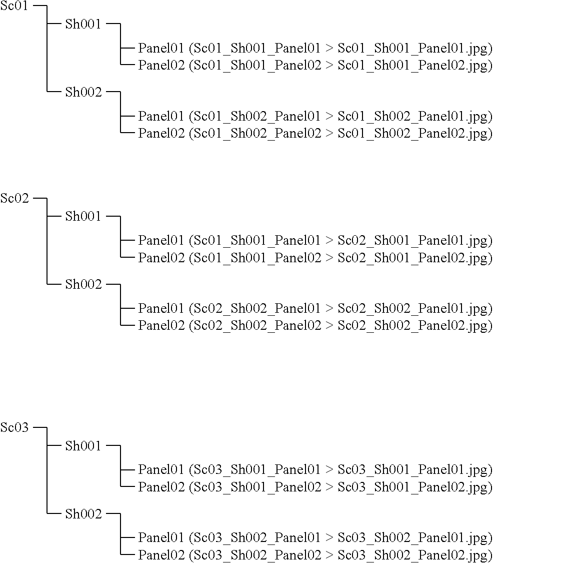

When this panel sequence is being edited to create the “animatic”, it is decided, for creative reasons, to remove Scene 2 from the edit. The remaining scenes could be described as follows (with the duration of panel included as it is detailed in the EDL).

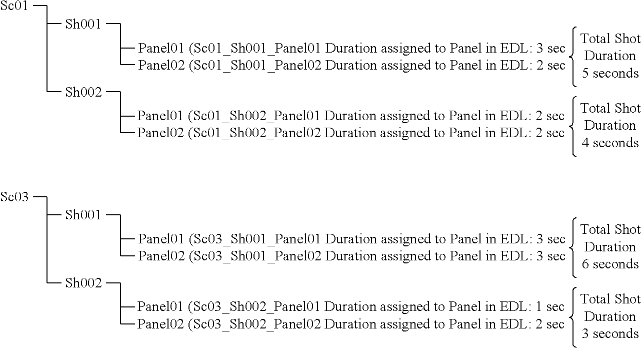

The storyboard artist could choose to keep the existing naming, with a gap where scene 2 previously existed. Alternatively the storyboard artist could request the system to renumber the scenes so that all scene and shot numbers run sequentially with no gaps for the remainder of the production (so Sc03 would become Sc02, Sc04 becomes Sc03 etc).

A third option for the ongoing naming for the remainder of the production of scenes and shots within any given sequence is available. By using a combination of lookup tables and exported panel filenames it is possible to combine both the sequential unbroken scene/shot naming (allowing the remainder of the production to proceed with a sequential unbroken scene/shot naming convention) with the automatic non-sequential option provided by the system. This allows the system to automatically rename sequences so that any numbering is sequential, without any gaps, for the remainder of the production, but these renumbered sequences still maintain a reference back (via the lookup tables) to the original panel naming convention defined by the storyboard artist at the outset of the production.

Once a suitable ongoing naming convention has been selected for the remainder of the production, the system can combine the duration applied to individual panels across a complete shot (containing multiple panels). Using the example on the previous page, if the storyboard artist has moved the virtual camera, from position A in the first panel (Sc01_Sh001_Panel01) to position B in the second panel (Sc01_Sh001_Panel02) then the system can interpolate that the camera moves from position A to position B over a total of 5 seconds, in effect creating an animated camera track from position A to position B over the specified period of time.

This interpolation process combining the duration (as defined in the EDL) of the individual panels, which have been collected together into a shot, with the location and orientation data of 3D objects, like the virtual camera, can also be applied to all the individual 3D objects (such as characters, vehicles and props) that may appear in those panels. Again using the example above if the storyboard artist has moved the Character Z from position C to position D and Character Y from position E to position F in the same panels (Sc01_Sh001_Panel01 and Sc01_Sh001_Panel02) then the system can interpolate the movement of the two characters from C to D and E to F over a 5 second period. As a result the system can create the basic “animation” that may have been applied to individual 3D objects over a number of static panels by the storyboard artist changing the position of a 3D object (such as a character, vehicle or prop) as they progress through the creation of the individual storyboard panels. As part of the interpolation process the system also considers factors such as direction and orientation of 3D objects over a number of panels. As a result, 3D objects can appear to move and rotate correctly (thereby stopping an object rotating more that 360 degrees for example). Additionally the possible interaction with other 3D objects such as walls (which may be defined in the 3D set) and other characters can also be factored into the interpolation of the animation, which may be created for a specific 3D object.

By creating the individual storyboard panels, the artist provides the system with keyframed positions and rotations of the 3D objects used in a series of panels. Besides basic interpolation techniques, the system can also utilize other functionality.

For example, a character may be required to walk on a pavement around a corner (making a 90 degree turn). If one panel (a first keyframe) shows the scene ‘before the corner’ and the next panel (a second keyframe) shows the scene ‘around the corner’ then normal linear interpolation would cause the object to take the shortest path which would be straight through the corner which may cause the character to appear to walk through a building. Using the collision detection feature however, the object could for example be given a collision radius of 1 metre. Thus, by animating the object the collision detection system would prevent the object going through the corner and instead force it to stay 1 metre away from the building that defines the corner. The collision behavior would cause the object's invisible collision sphere to ‘slide’ along the building around the corner.

Furthermore, instead of linear interpolation other types of interpolation curves could be used to provide smoother movement and rotation.

Another example uses a “look-ahead” function. In this scenario, three keyframes are defined and a character is again required to make a 90 degree turn (but without obstacles this time).

The first panel defines the object's starting position, the second panel is 5 meters forward from the starting position and the third panel is 5 meters to the right of this second panel (creating a 90 degree turn). Normal linear interpolation would have the object ‘snap’ from looking straight forward to looking sharply right when interpolated just before to just after the second panel. Instead, the system can apply a “look-ahead” function during the animation of this path, causing the character not to rotate towards its direction on the following frame but slowly to add a target rotation that will occur for example ten frames ahead of the current point. This will resolve the instant snapping when interpolating over the second panel, and instead provide a smooth animation where the object will gradually turn itself in the direction of its intended path.

Crucially the storyboard artist does not need to understand, or even be aware of the ability of the system to interpolate this animation from the movement of cameras and other 3D objects over a number of panels. The system presents no “animation” controls to the storyboard artist whilst they are creating the storyboards for a particular project. The storyboard artist simply positions the camera and characters over a number of sequential panels, and then draws over the top of them to add additional detail, in such a way as to tell the story as detailed in the script.

In effect each individual storyboard panel becomes a “keyframe”. The system, by tracking the orientation data of the 3D objects and their location within a particular panel sequence, allows for the 3D data contained in the panel keyframes to be combined with a time component, for each panel, defined by an EDL which is created by an editor, working on a professional editing system.

Whilst the use of an EDL enables a more accurate duration (as detailed by the script and any guide audio track available) to be assigned to individual panels, the system can also export the interpolated 3D data using user definable default duration. All the panels will have the same duration but the system can still interpolate for any objects that the storyboard artist might move over a number of panels. Alternatively the system can also simply export the static 3D data for all the objects in a single panel without requiring any duration being assigned to the panel, thereby creating an 3D data “snapshot” of the camera and models in the shot at any given moment.

The value of this interpolated 3D data is enhanced by the ability of the system to export this data in a format that is accessible to other 3D digital content creation (DCC) software, such as Autodesk's Maya, and Autodesk's 3DSMax.

In order to further enhance the transfer of 3D data between the system and other 3D DCC software the system contains a user-managed look-up table that lists all the low-polygon 3D sets and 3D objects (proxies), used in any particular storyboard project. This lookup table links the low-polygon proxies (used in the system) to the location and filename of the corresponding final high-polygon model (used in the 3D DCC), which may be stored in an alternative location. These high-polygon objects are not used by the storyboarding system directly, but are instead used, by the 3D DCC software to create the “final” output for the television series or film in question.

By enabling the storyboard system to know the location of the high polygon version, it can automatically “exchange” the low polygon proxies for the high polygon final output when writing out the data for the 3D DCC that will be used for the final production. When the storyboard system exports the 3D data, the system writes into a file the location and orientation of the 3D set or 3D object and any animation that may have been applied to a 3D object over a number of panels, but, by using the lookup table as a reference, instead of using the location and filename of the low-polygon model, the system substitutes it for the location and filename of the high-polygon model. As a result the exported 3D data associates the low-polygon model's orientation and location with the corresponding high-polygon counterpart. The system will do this for all the 3D sets and 3D objects for the story panel to be exported.

The virtual camera that was used in the system to frame each individual shot does not however require a corresponding “high polygon” version, so does not require a “look-up table” entry. Instead the virtual camera's 3D orientation data, including any lens information is converted using a suitable conversion matrix to a corresponding matching camera in the 3D DDC software being used in the final production. As both cameras, in the storyboard system and the 3D DCC system are ultimately defined digitally it is possible, using the correct conversion matrix (and transferring the matching 3D sets and 3D objects also), to get a pixel accurate match between the two cameras (one in the storyboarding system described here and one in the 3D DCC software) and a corresponding match in the images that they present to the viewer.

This ability of the system, to automatically enable the accurate recreation of the shot originally created by the storyboard artist in an alternative 3D DCC system, negates the requirement of any additional 3D operators to undertake the process of scene setup whereby a 3D scene is recreated from a traditional 2D storyboard panel. Optionally the system also allows for the low polygon 3D proxies used in the storyboarding phase of the production to be automatically swapped for final high polygon versions used in the final production

The ability of the system to create an animation or movement track for the camera and individual 3D objects in each scene, by interpolating the location of a 3D object (as defined in a number of storyboard panels) over a period of time (provided by a specific EDL or a default value provided by the system) and subsequently transfer this animation data into an alternative 3D DCC also negates the need for a 3D operator to undertake what is often the next stage of the production process, that of digital layout. The 3D data file that the system creates to transfer the data into an alternative 3D DCC, almost totally automates the process of digital layout, leaving the 3D operator to make only minor adjustments to the automated digital layout that the system generates in the corresponding 3D DCC system used for the final production.

The storyboarding system also allows for the export of other non-graphical data, which can be used in other aspects of the production process. As the system requires the storyboard artist to establish a comprehensive naming convention for any particular storyboard project, this naming convention can also be exported to underpin later stages of the production. By combining the structure laid out by any particular naming convention with other data the system can additionally export data which can used to create a route sheet or guide sheet that can be used to manage all the other stages involved in a computer generated imagery (CGI) television series or film production. A route sheet details, in sequence, all the scenes and shots, which are present in any specific sequence (such as an individual episode) and can include details such as the shot name, the duration of specific shots, any particular production annotations which may have been added, the artist who created the storyboard panels, image thumbnails and the type of edit used between panels. The system generates all these details automatically by combining data that exists within the system itself (for example the annotations entered by the artist) with duration and editing data contained in the EDL. The system exports this data in a “standard” comma-separated values (CSV) file format, which can be imported into other software, such as Microsoft Excel or uploaded to an online spreadsheet such as GoogleDocs.

1. A computer-implemented method for generating a storyboard image, the method comprising:
i) retrieving three-dimensional image data defining at least one three-dimensional object;
ii) rendering the three-dimensional image data from a predefined viewpoint to generate two-dimensional background image data including a two-dimensional representation of the or each three-dimensional object visible from the predefined viewpoint; and
iii) superimposing two-dimensional foreground image data over the two-dimensional background image data to generate a composite two-dimensional image representing the storyboard image.

2. A method according to claim 1, wherein the two-dimensional foreground image data comprises an alpha channel and the superimposing step comprises alpha compositing of the two-dimensional foreground image data over the two-dimensional background image data.

3. A method according to claim 1, wherein the superimposing step comprises a colour key process in which each pixel of a first colour in the two-dimensional foreground image data is replaced by a corresponding pixel in the two-dimensional background image data.

4. A method according to claim 1, further comprising modifying the two-dimensional background image data prior to carrying out step (iii) by superimposing a partially-transparent layer over the two-dimensional background image data.

5. A method according to claim 1, wherein one or more elements of the two-dimensional foreground image data is at least partially generated by auto-tracing respective three-dimensional objects.

6. A method according to claim 5, wherein auto-tracing each of the respective three-dimensional objects comprises creating first and second duplicates of the respective three-dimensional object; identifying each polygon within the second duplicate; calculating a normal for each identified polygon; moving the polygon along the normal and away from the centre of the object by a predefined distance; inverting the normal for each polygon; and rendering the first and second duplicates without any shading or lighting, thereby generating a two-dimensional outline of the respective three-dimensional object.

7. A method according to claim 1, further comprising storing two associated files, one containing the three-dimensional image data defining the or each three-dimensional object and the other containing the two-dimensional foreground image data.

8. A method according to claim 7, further comprising periodically comparing a timestamp associated with each of the two files, the timestamp indicating the time of the last modification of the two files, with a pre-recorded timestamp, the pre-recorded timestamp being updated after the comparison.

9. A method according to claim 7, further comprising storing one or more text annotations.

10. A method according to claim 9, further comprising superimposing the or each text annotations over the composite two-dimensional image representing the storyboard image.

11. A method according to claim 7, further comprising superimposing a name, such as a filename, associated with one of the two associated files over the composite two-dimensional image representing the storyboard image.

12. A method according to claim 1, further comprising defining one or more characteristics of a virtual camera located at the predefined viewpoint, the rendering of the three-dimensional image data being done in accordance with the or each characteristic of the virtual camera.

13. A method according to claim 1, further comprising responding to user input requesting movement of the predefined viewpoint by determining the current location of the predefined viewpoint; calculating a new position for the location of the predefined viewpoint dependent on the user input; and changing the location of the predefined viewpoint to the new position unless the path between the current and new locations of the predefined viewpoint passes through a surface of one of the or each three-dimensional objects.

14. A method according to claim 1, further comprising responding to user input requesting movement of one of the or each three-dimensional objects by adjusting the location of the three-dimensional object in accordance with the user input and snapping the three-dimensional object such that a predetermined surface of the three-dimensional object is positioned in alignment with a predetermined surface of another object if the three-dimensional object is moved within a predefined range of the predetermined surface of the other object.

15. A method for generating a sequence of storyboard images, the method comprising performing the method of claim 1 successively to generate each of the storyboard images in the sequence.

16. A method according to claim 15, wherein each of the storyboard images in the sequence is associated with a respective duration, the respective durations defining the duration for which each of the storyboard images in the sequence is displayed for when the sequence is played.

17. A method according to claim 16, wherein the respective durations associated with each of the storyboard images is retrieved from an edit decision list.

18. A method according to claim 15, further comprising selecting first and second storyboard images in the sequence as first and second keyframes respectively, the first and second keyframes defining start and finish locations for the at least one three-dimensional object and/or the predefined viewpoint; and calculating appropriate locations for the at least one three-dimensional object on each of the storyboard images in the sequence between the first and second keyframes by interpolation between the start and finish locations.

19. A method according to claim 15, further comprising generating a route sheet comprising data related to each of the storyboard images in the sequence.

20. A system for generating a storyboard image or a sequence of storyboard images comprising a processor adapted to perform the method of claim 1.

21. A computer program comprising computer-implementable instructions, which when executed by a programmable computer causes the programmable computer to perform a method in accordance with claim 1.

22. A computer program product comprising a computer program, which when executed by a programmable computer causes the programmable computer to perform a method in accordance with claim 1.

23. (canceled)

24. (canceled)
